(19) United States
(12) Patent Application Publication
(10) Pub. No.: US 2012/0060329 A1
(43) Pub. Date: Mar. 15, 2012

(54) CORD LOCKER AND WINDOW COVERING HAVING THE CORD LOCKER FOR LENGTH ADJUSTMENT

(75) Inventor: De-Jun Zhang, Taichung City (TW)

(73) Assignee: NIEN MADE ENTERPRISE CO., LTD., Taichung City (TW)

(21) Appl. No.: 12/882,509

(22) Filed: Sep. 15, 2010

(51) Int. Cl. F16G 11/10

(52) U.S. Cl. 24/115 F

(57) ABSTRACT

A cord locker includes a plate with a through hole and a sidewall connected to an edge of the plate. The sidewall has at least a slot. The cord locker is incorporated in a length adjusting mechanism of a window covering, in which a cord has an end fixed to a top rail of the window covering and the other end passing through the through hole of the plate via a bottom of the cord locker, and then the cord is turned to pass through the slot of the sidewall, and then cross the plate and turn back to pass through the slot for fastening the cord and adjusting the length of the cord that the cord is quickly fastened to adjust a length of the window covering.

### BACKGROUND OF THE INVENTION

1. Field of the Invention

The present invention relates generally to a window covering, and more particularly to a cord locker to fasten the cord and a window covering equipped with the cord locker to adjust a length of window covering blanket or slats.

2. Description of the Related Art

Window coverings, such as window blinds, usually have a top rail and a bottom rail connected together by a cord. Conventional window blinds have a constant distance between the top rail and the bottom rail on which the cords are fastened by nails. The lengths of the cords are fixed once the cords are nailed so that one cannot adjust the distance between the top rail and the bottom rail. In other words, the length of such window blind is fixed and is not adjustable.

An improved cord locker, as shown in FIG. 1 and FIG. 2, is provided to overcome this problem. A cord locker 1 has a round barrel 2 with a two-order opening 3, which is wider at bottom and narrower at top. In operation, a cord 5 passing through slats 4 is inserted into the opening 3 of the barrel 2 and tied a knot 5a that the knot is received in the wider portion of the opening 3, and then, the barrel 2 is inserted into a bore 6a at a bottom of a bottom rail 6 that user may change a position of the knot to adjust a distance between the top rail and the bottom rail. However, this cord locker still has some drawbacks.

As shown in FIG. 2, a section of the cord 5 extends along a slot between the barrel 2 and a sidewall of the bore 6a of the bottom rail 6, and the knot 5a is rested on a ring portion 3a in the opening 3 that sometimes the cord 5 may draw the cord locker 1 out of the bore 6a or the knot 5a out of the opening 3 of the barrel 2 when the bottom rail 6 is overly pressed downward. Besides, a tail of the cord 5b is often hanging out which is unpleasant to see.

### SUMMARY OF THE INVENTION

The primary objective of the present invention is to provide a cord locker of a window covering, which may quickly fasten the cord as well as hide the cord.

The secondary objective of the present invention is to provide a window covering using the cord locker, with which user may adjust the length of the cord and firmly connect the cord lock to the bottom rail.

According to the objectives of the present invention, a cord locker includes a plate with a through hole and a sidewall connected to an edge of the plate. The sidewall has at least a slot. The cord locker is incorporated in a length adjusting mechanism of a window covering, in which a cord has an end fixed to a top rail of the window covering and the other end passing through the through hole of the plate via a bottom of the cord locker, and then the cord is turned to pass through the slot of the sidewall, and then cross the plate and turn back to pass through the slot for fastening the cord and adjusting the length of the cord.

### BRIEF DESCRIPTION OF THE DRAWINGS

FIG. 1 is a partial perspective view of the conventional window covering and the conventional cord locker;

FIG. 2 is a sectional view of the conventional window covering and the conventional cord locker;

FIG. 3 is a partial perspective view of the window covering and the cord locker of a preferred embodiment of the present invention;

FIG. 4 and FIG. 5 are perspective views of the cord locker of the preferred embodiment of the present invention;

FIG. 6 is a top view of the cord locker of the preferred embodiment of the present invention;

FIG. 7 is a sectional view along the 7-7 line of FIG. 6;

FIG. 8 is a sketch diagram of the operation of the cord locker of the preferred embodiment of the present invention, showing the cord passing through the through hole;

FIG. 9 is a sectional view of FIG. 8;

FIG. 10 is a sketch diagram of the operation of the cord locker of the preferred embodiment of the present invention, showing the cord turned downward after passing through the through hole;

FIG. 11 is a sectional view of FIG. 10;

FIG. 12 is a perspective view of the preferred embodiment of the present invention, showing the cord locker received in the bore of the bottom rail;

FIG. 13 is a sectional view of the window covering and the cord locker of a preferred embodiment of the present invention;

FIG. 14 is a sketch diagram, showing another utility of the cord locker; and

FIG. 15 is a top view of FIG. 14.

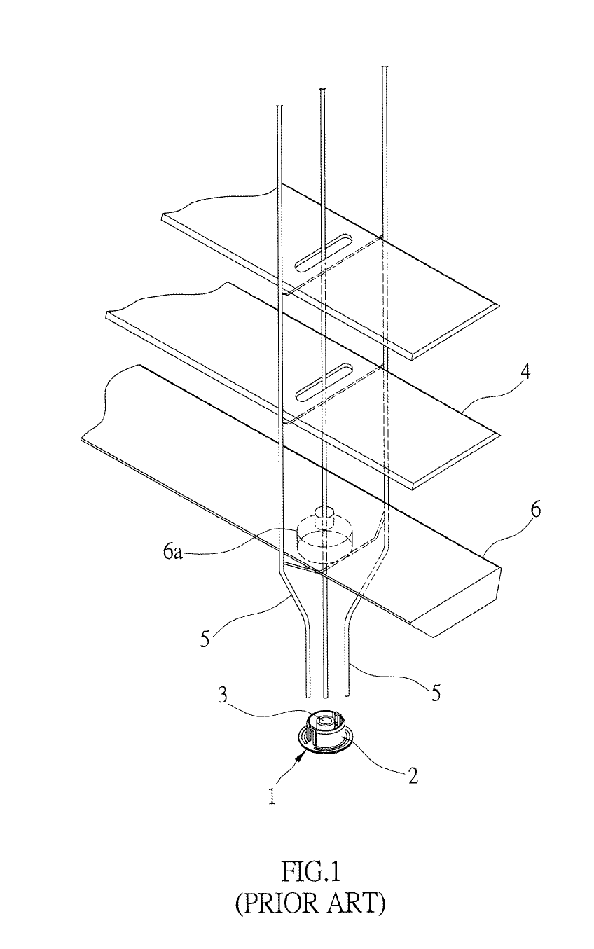

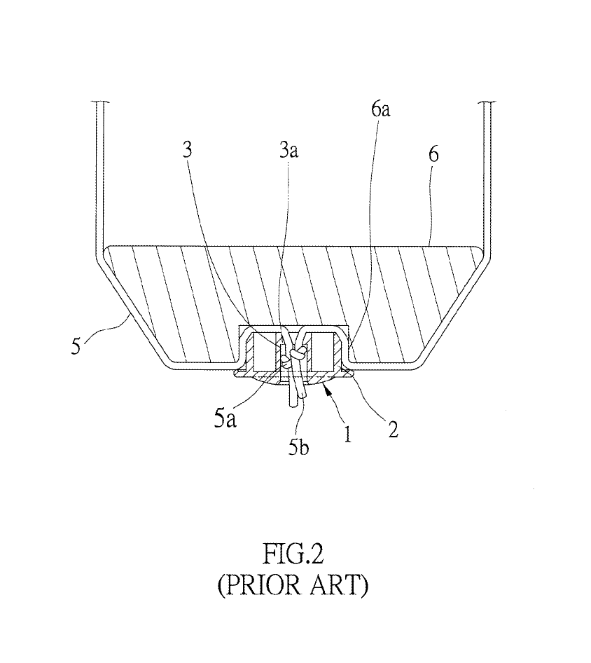

### DETAILED DESCRIPTION OF THE INVENTION

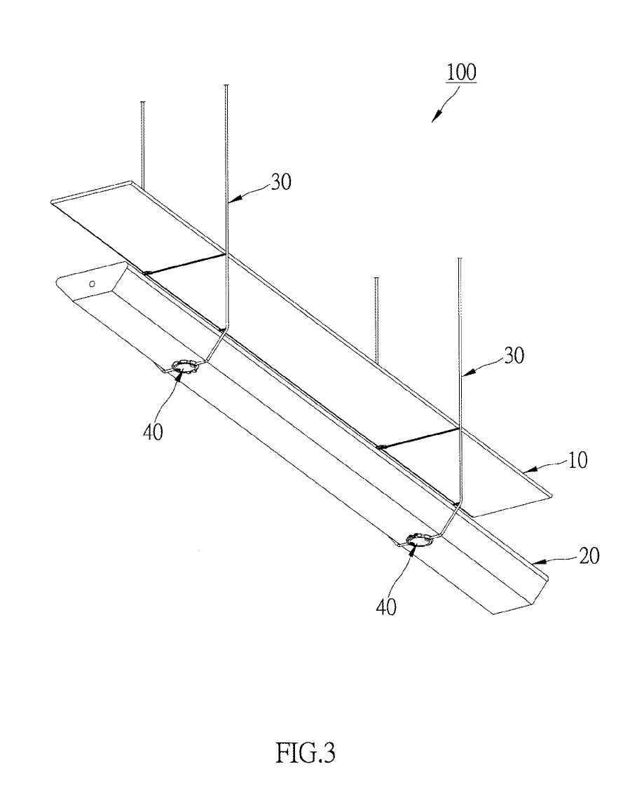

As shown in FIG. 3, a window covering 100 of the preferred embodiment of the present invention includes a plurality of slats 10 (only one slat is shown in FIG. 3), a bottom rail 20, two cords 30 and two cord lockers 40. The cords 30 extend at opposite sides of the slats 10 with top ends fastened to a top rail (not shown) and bottom ends fastened to the cord locker 40, which is connected to the bottom rail 20, and the bottom ends of the cords 30 are hidden completely to show a entire look of the window covering 100.

We've described the structure of the cord locker 40 of the preferred embodiment above, and now we are going to describe its operation with the cords 30.

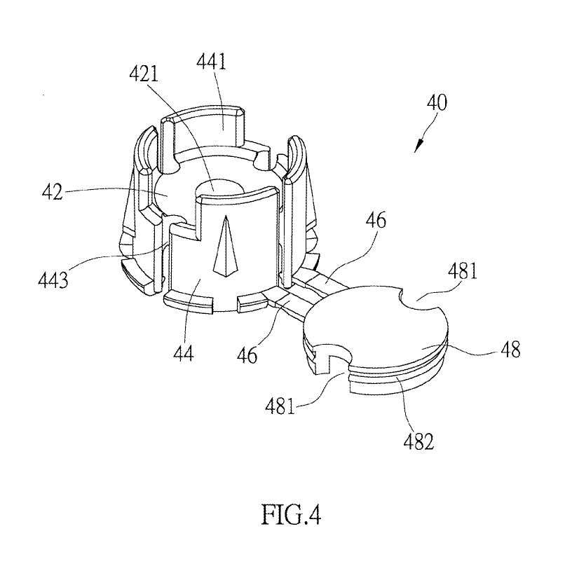

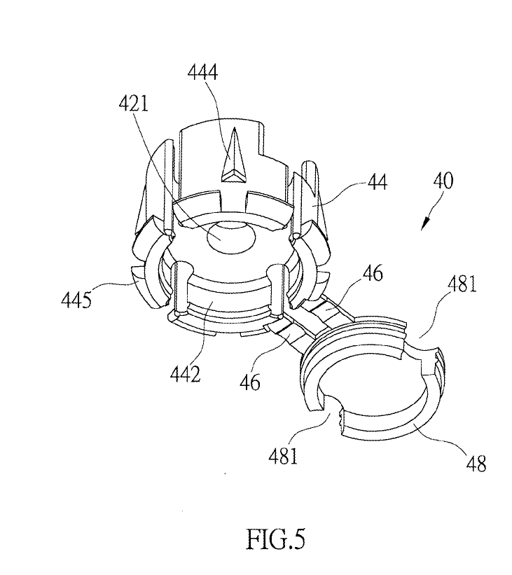

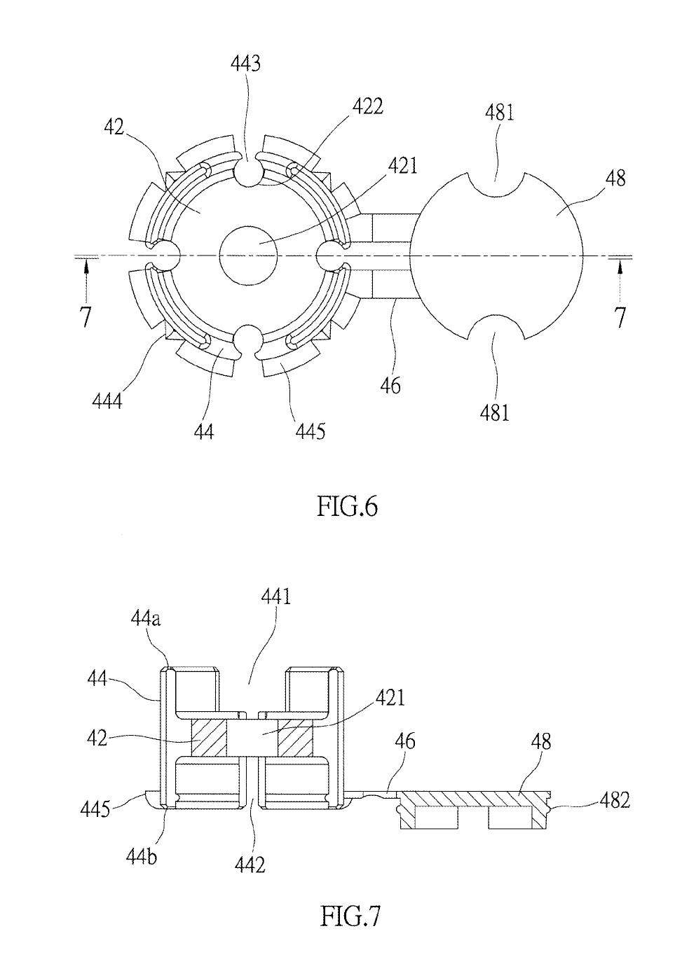

As shown in FIG. 4 to FIG. 7, the cord locker 40 includes a plate 42, a sidewall 44, two flexible belts 46 and a lid 48.

The plate 42 has a round disk with a round through hole 421 at a center thereof at four recesses 422 at an edge thereof. The sidewall 44 connects its middle to the edge of the plate 42 with a top 44a and a bottom 44b that there are an upper room 441 above the plate 42 and a bottom room 442 under the plate 42. In addition, the sidewall 44 has four slots 443 extended from the top 44a to the bottom 44b, and each slot 443 is in association with one of the recesses 422 of the plate 42 and communicated with the upper room 441 and the bottom room 442 respectively. The sidewall 44 further has several pyramidal protrusions 444 at an outer side and several stop blocks 445 at the bottom 44b.

The belts 46 have ends fastened to the bottom 44b of the sidewall 44.

The lid 48 is a round disk and the other ends of the belts 46 are fasten to the lid 48. The lid 48 has two recesses 481 thereof and a protrusion 482 at an edge thereof.

The cord locker 40 is incorporated in a length adjusting mechanism of the window covering 100, and hereafter, we describe how the cord locker 40 fastens the cords 30 and hides tails of the cords hereafter.

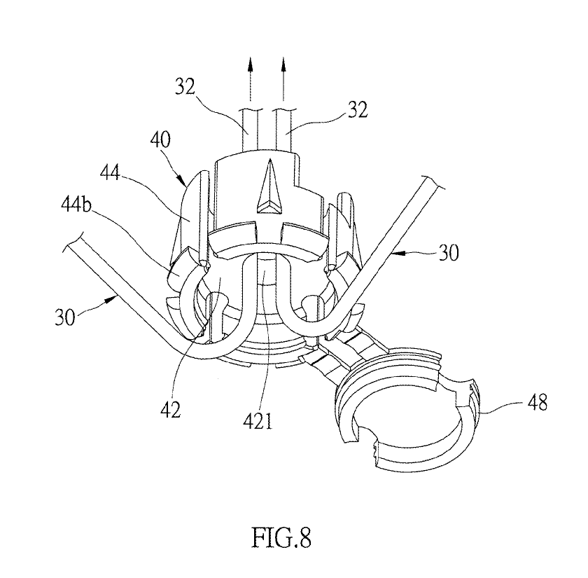

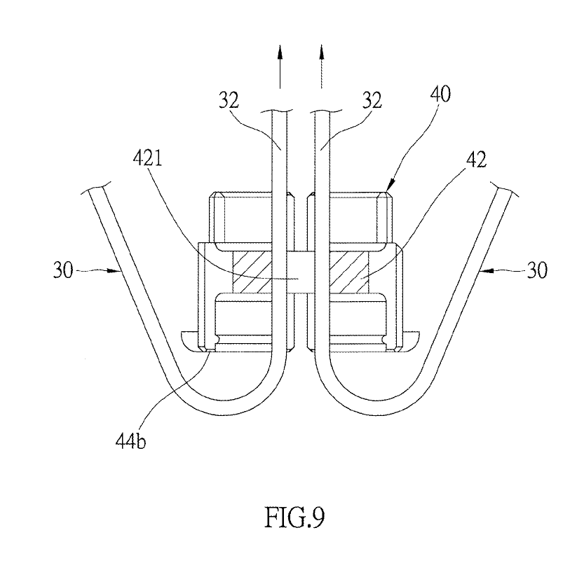

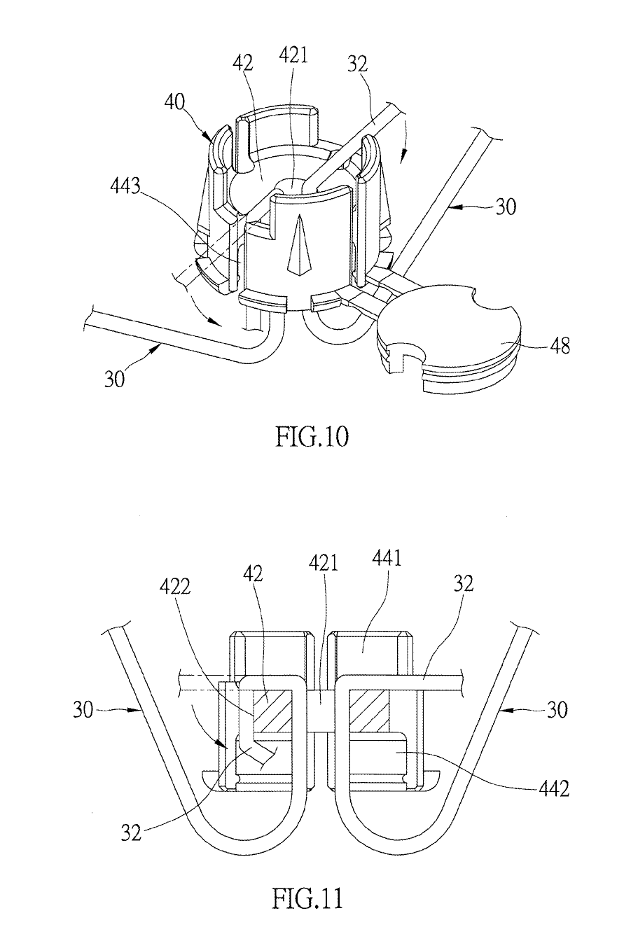

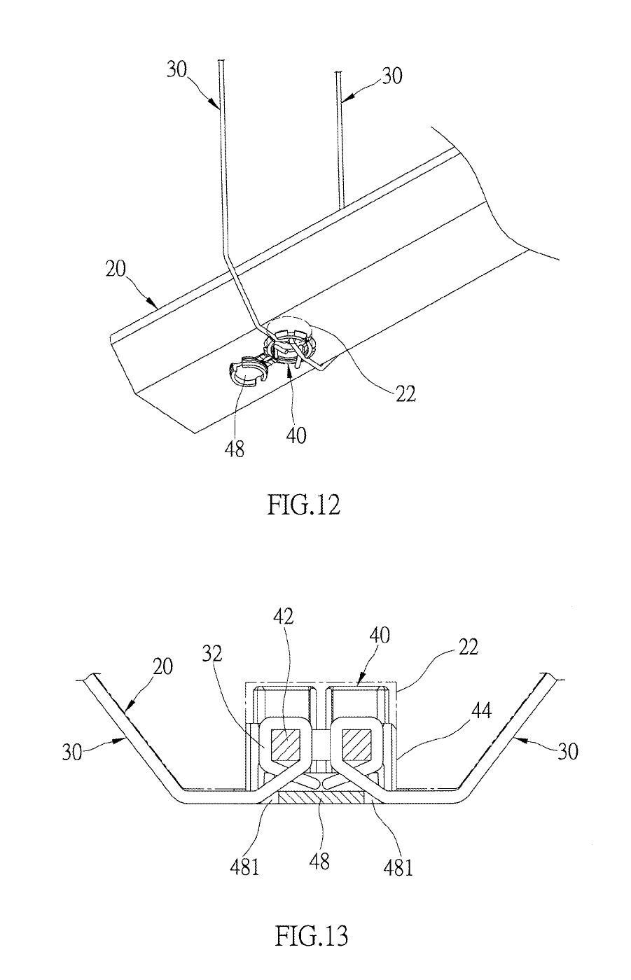

As shown in FIG. 8 and FIG. 9, before the cords 30 are fastened to the cord locker 40 and the bottom rail 20, the tails of the cords pass through the through hole 421 of the plate 42 via the bottom 44b of the sidewall 44 (from a first side to a second side of the plate 42), and then turn right and left, as shown in FIG. 10 and FIG. 11, to pass through the slots 442 of the sidewall 44, and then make a U-turn to be engaged with the recesses 422 of the plate 42 that the tails of the cords 30 are received in the bottom room 442. Next, as shown in FIG. 12, the cord locker 40 with the cords 30 fastened thereon is fitted to a bore 22 of the bottom rail 20 that the pyramidal protrusions 444 on the outer side of the sidewall are pressed on a sidewall of the bore 22 and the stop blocks 445 in contact with the bottom of the bottom rail 20 to firmly fix the cord locker 40 to the bottom rail 20. User may change the positions of the cords 30 engaged with the recesses 422 of the plate 42 to adjust a distance between the top rail and the bottom rail. At last, the lid 48 is engaged with the sidewall 44 to close the bottom room 442, as shown in FIG. 13. The recesses 481 of the lid 48 give space for the cords 30 to prevent the lid 48 from disengagement with the sidewall 44 by the cords 30, and edges of the recesses 481 of the lid 48 press the cords 30 to prevent the cords from loosing. Besides, the protrusions 482 of the lid 48 press an inner side of the sidewall 44 to secure the lid 48.

In conclusion, the present invention provides the cords 30 wound around the plate 42 to replace the knot and to prevent the cords 30 from loosing from the cord locker 40 because the bottom rail 20 is pressed downwards. Besides, the way of winding the cords 30 around the plate 42 provides an easy way of adjusting a length of the cords 30 to change and adjust a distance between the top rail and the bottom rail. The tails of the cords 30 are received in the bottom room 442 of the cord locker 48 and are covered by lid 48 to provide the window covering 100 a complete aspect.

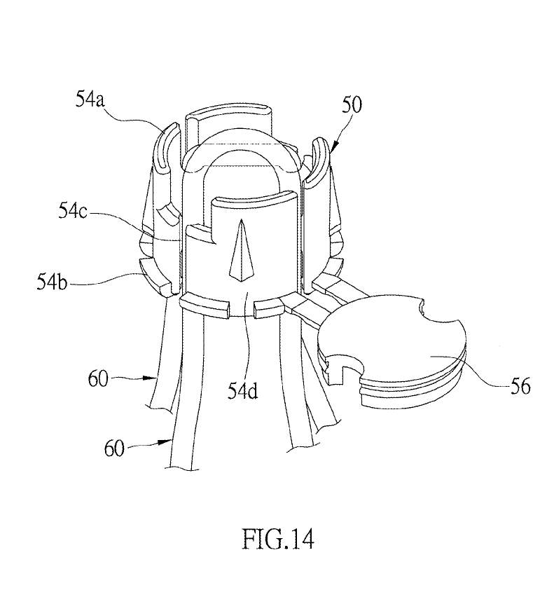

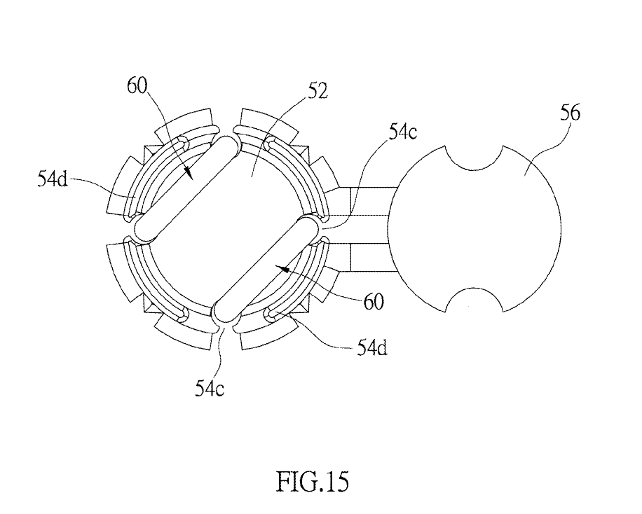

Except for the way of the cord locker fastening the cords as described above, the purpose may be achieved without the through hole on the plate. As shown in FIG. 14 and FIG. 15, a cord locker 50 has a plate 52 and a sidewall 54 as above. The sidewall 54 is provided with four slots 54c from a top 54a to a bottom 54b to form four walls 54d between the slots 54c. Cords 60 pass through the slots 54c and cross an inner side of the walls 54d and pass through the slots 54c on the other sides of the walls 54d. It fastens the cords 60 quickly and adjusts lengths of the cords 60 in an easy way.

The description above is a few preferred embodiments of the present invention and the equivalence of the present invention is still in the scope of claim construction of the present invention.

What is claimed is:

1. A cord locker for fastening a cord of a window covering, comprising:
a plate; and
a sidewall, which is connected to an edge of the plate to form an upper room, which is above the plate, and a bottom room, which is under the plate, therein, having a top and a bottom and at least two slots extended from the top to the bottom and communicated with both of the upper room and the bottom room.

2. The cord locker as defined in claim 1, further comprising a lid to be engaged with the bottom of the sidewall to close the bottom room.

3. The cord locker as defined in claim 2, wherein the lid has a flexible belt to be connected to the sidewall.

4. The cord locker as defined in claim 1, wherein the cord has an end connected to the top rail, and an opposite end passing through one of the slot of the sidewall, and then crossing wall beside the slot to pass through the slot on an opposite side of the wall.

5. The cord locker as defined in claim 2, wherein the lid has a recess to be communicated with the slot when the lid is engaged with the sidewall for the cord to pass through.

6. The cord locker as defined in claim 5, wherein an edge of the recess of the lid presses the cord.

7. The cord locker as defined in claim 1, wherein the plate has a recess on the edge and communicated with the slot of the sidewall to be engaged with the cord when the cord passes through the slot and makes a U-turn to be engaged with the recess of the plate.

8. The cord locker as defined in claim 4, wherein the sidewall has at least a protrusion on an outer side thereof.

9. A cord locker for fastening a cord of a window covering, comprising:
a plate having a through hole; and
a sidewall, which is connected to an edge of the plate, having a top and a bottom and at least a slot extended from the top to the bottom;
wherein the cord has an end passing through the through hole of the plate from a first side to a second side and then passing through the slot, and then making a U-turn to pass through the slot again to the first side of the plate.

10. The cord locker as defined in claim 9, further comprising a lid, wherein the sidewall surrounds an upper room, which is above the plate, and a bottom room, which is under the plate, therein, and the slot is communicated with both the upper room and the bottom room, and the lid is engaged with the bottom of the sidewall to close the bottom room.

11. The cord locker as defined in claim 10, wherein the lid has a recess to be communicated with the slot when the lid is engaged with the sidewall for the cord to pass through.

12. The cord locker as defined in claim 11, wherein an edge of the recess of the lid presses the cord.

13. The cord locker as defined in claim 10, wherein the lid has a flexible belt to be connected to the sidewall.

14. The cord locker as defined in claim 9, wherein the plate has a recess on the edge and communicated with the slot of the sidewall to be engaged with the cord when the cord passes through the slot and makes a U-turn to be engaged with the recess of the plate.

15. The cord locker as defined in claim 9, wherein the sidewall has at least a protrusion on an outer side thereof.

16. A length adjusting device of a window covering for adjusting a distance between a top rail and a bottom rail of the window covering, comprising:
at least a cord locker, which is connected to a bottom of the bottom rail, having a top and a bottom, and having a plate and a sidewall, wherein the plate has a through hole, and the sidewall is connected to an edge of the plate and has at least a slot from the top to the bottom; and
at least a cord having an end connected to the top rail, and an opposite end passing through the through hole of the plate via the bottom of the cord locker, and then passing through the slot of the sidewall, and then making an U-turn to pass through the slot again.

17. The length adjusting device as defined in claim 16, wherein the cord locker has an upper room above the plate and a bottom room under the plate which the slot of the sidewall is communicated with both of the upper room and the bottom room, and the cord locker further has a lid to be engaged with the sidewall to close the bottom room.

18. The length adjusting device as defined in claim 17, wherein the lid has a recess to be communicated with the slot when the lid is engaged with the sidewall for the cord to pass through.

19. The length adjusting device as defined in claim 18, wherein an edge of the recess of the lid presses the cord.

20. The length adjusting device as defined in claim 16, wherein the plate has a recess on the edge and communicated with the slot of the sidewall to be engaged with the cord when the cord passes through the slot and makes a U-turn to be engaged with the recess of the plate.
